(19) United States
(12) Patent Application Publication
(10) Pub. No.: US 2010/0312512 A1
(43) Pub. Date: Dec. 9, 2010

(54) Single light source automatic calibration in distributed temperature sensing

(76) Inventor: Mahesh U. Ajgaonkar, Buda, TX (US)

Correspondence Address: MICHAEL A. ERVIN, 8202 TALBOT COVE, AUSTIN, TX, 78746, US

(21) Appl. No.: 12/802,499

(22) Filed: Jun. 8, 2010

Related U.S. Application Data
(60) Provisional application No. 61/268,080, filed on Jun. 8, 2009.

(51) Int. Cl. G01K 15/00; G06F 19/00; G01K 11/32

(52) U.S. Cl. 702/99; 356/301

(57) ABSTRACT

System and method for auto correcting temperature measurement in a system using a fiber optic distributed sensor and a single light source by making use of both spontaneous and stimulated Raman backscattering.

### CROSS REFERENCE TO RELATED APPLICATIONS

This application claims the benefit of U.S. provisional Ser. No. 61/268,080 filed Jun. 8, 2009.

### BACKGROUND OF THE INVENTION

1. Field of the Invention

The present disclosure relates generally to distributed temperature sensing (DTS) systems and, more particularly, to methods and systems for automatic calibration of a DTS system using a single light source.

2. Description of Related Art

For several years, fiber optic sensors, and in particular, DTS systems, where an optical fiber is used as sensing medium based, have provided higher bandwidth, inherently safe operation (no generation of electric sparks), and immunity from EMI (Electromagnetic Interference) for parameter measurements. DTS systems are used in many industries, including, the oil and natural gas industry, electrical power cable industry, process control industry, and many other industrial applications where distributed asset monitoring is required. Generally, DTS systems use spontaneous Raman scattering as an underlying principle. A light source, typically a laser, launches a primary laser pulse that gives rise to two spectral components namely Stokes, which has a lower frequency and higher wavelength than launch laser pulse, and anti-Stokes, which has higher frequency and lower wavelength than the launch laser pulse. The anti-Stokes signal is usually about an order of magnitude weaker than the Stokes signal at room temperature and is typically a temperature sensitive signal while the Stokes signal is weakly temperature dependent. The ratio between the anti-Stokes and Stokes signals may be used to determine the temperature of the optical fiber.

One challenge with current systems and techniques is the ability to measure temperature profiles accurately. A key factor in obtaining accurate and reliable temperature measurement using fiber optic DTS technology is the optical property of the fiber. DTS technology derives temperature information from two backscattered signals that are in different wavelength bands, one being the Raman anti-Stokes signal, and the other being either Raman Stokes or Rayleigh signal. Since optical fiber has different attenuation characteristics as a function of wavelength, a proper correction needs to be made so that the two signals exhibit the same wavelength attenuation. With the assumption that the attenuation profile is exponentially decaying as a function of distance, an exponential function with the exponent called Differential Attenuation Factor (DAF) is multiplied to the Stokes or Rayleigh data as a correction factor to match the attenuation profile to that of the Anti-Stokes signal. The temperature profile is then calculated from the ratio of the two signals. DAF is the difference in attenuation between two signal wavelengths and is typically determined by the fiber material. Further fine adjustment on actual DAF can be made during the calibration process.

The conventional approach of using DAF has an inherent limitation in many cases because of the assumption that the attenuation of the optical signal along the sensing fiber path is always exponentially decaying, whereas in reality, many different factors can cause the actual attenuation to deviate from the exponential form. For example, localized mechanical stress or strain applied to the sensing fiber can cause an increase in attenuation of which the magnitude can also be wavelength dependent. In another example, hydrogen gas ingression can cause the overall attenuation to be continuously fluctuating. One typical way to deal with this type of abnormality is to divide the entire fiber span into several sections and applying different DAF's for each section. However, as the condition of the fiber changes as a function of time, it will require re-sectioning and readjusting DAF's repeatedly, or in some cases, the attenuation change is varying so much that sectioning may not be feasible at all. Furthermore, deriving accurate DAF's require knowledge of temperature at the end points of each section. Such requirement cannot be met in most cases once the sensing fiber is installed at the application sites.

Thus methods and systems to accurately determine system profiles as well as auto calibrate the system are needed.

One successful approach to this problem utilizes two light sources in which their wavelengths are selected such that the anti-Stokes signal of the primary light source coincides in wavelength with the Stokes signal of the secondary light source. Such method enables accurate and repeatable temperature measurement independent of the changes in the fiber condition.

An example of this approach is described in US Patent Publication 2007/0223556, using two light sources, the primary one a 1064 nm laser source, the secondary one a 980 nm laser source. The 980 nm Stokes signal is used to produce a new Stokes backscattered signal that overlaps in wavelength with the 1064 nm backscattered anti-Stokes signal. The ratio between the processed 980 nm Stokes signal and 1064 nm Stokes signal produces the calibration factor that replaces DAF derived exponential correction factor. In subsequent temperature measurement, the DTS system uses 1064 nm laser to take Stokes and anti-Stokes signals, apply the calibration factor to the Stokes signal, and then use the ratio to calculate temperature information.

Such approaches have significantly improved accuracy and enabled auto calibration of DTS systems, but with a concomitant increase in system complexity and cost. There is a need then for improved systems with lower component counts, less complexity, and lower cost that provide accurate and automatic determination of differential attenuation factors between temperature sensitive signals such as backscattered anti-Stokes and very weakly temperature sensitive backscattered Stokes or Rayleigh signals.

### BRIEF SUMMARY OF THE DISCLOSURE

The present disclosure provides systems and methods for automatic calibration of a DTS system using a single light source as well as determining profiles of the system. For example, the present disclosure determines the different attenuation profiles of backscatter components of an optical signal traveling through the system to determine an accurate temperature profile.

An aspect of this is a method for auto correcting temperature measurement in a system using a fiber optic distributed sensor and a single light source including at least the steps of: transmitting a first optical signal from the single light source at a first power level, the first optical signal generating a first set of backscattered spontaneous Rayleigh, Raman Stokes, and Raman anti-Stokes signals; collecting, filtering, and measuring the first set of backscattered signals from the first optical signal and calculating an OTDR attenuation profile of the spontaneous backscattered Rayleigh signal and the spontaneous backscattered Raman Stokes signal; transmitting a second optical signal from the single light source at a second and higher power level; the second power level sufficient to generate a new stimulated Raman Stokes signal of higher power than the first spontaneous Raman Stokes signal; collecting, filtering, and measuring a second set of backscattered stimulated Rayleigh, Raman Stokes, and Raman anti-Stokes signals from the new stimulated Raman Stokes signal; calculating a temperature profile based on the second set of backscattered stimulated Rayleigh, Raman Stokes, and Raman anti-Stokes signals from the new stimulated Raman Stokes signal; and auto calibrating the temperature profile using the OTDR attenuation profile of the backscattered spontaneous Rayleigh, backscattered spontaneous Raman Stokes, and/or backscattered stimulated Raman Stokes signals.

### BRIEF DESCRIPTION OF THE DRAWINGS

For a more complete understanding of the present invention, reference is now made to the following drawings, in which:

FIG. 1 is a block diagram of an automatic calibrating DTS system, in accordance with embodiments of the present disclosure;

FIG. 2 are spectral components from a spontaneous Raman regime, in accordance with embodiments of the present disclosure;

FIG. 3 are spectral components from spontaneous and stimulated Raman regimes, in accordance with embodiments of the present disclosure; and

FIG. 4 a flowchart of a method for determining a temperature profile of a DTS system, and autocorrecting that profile, in accordance with embodiments of the present disclosure.

### DETAILED DESCRIPTION OF THE DISCLOSURE

In the following detailed description, reference is made to the accompanying drawings that illustrate embodiments of the present invention. These embodiments are described in sufficient detail to enable a person of ordinary skill in the art to practice the invention without undue experimentation. It should be understood, however, that the embodiments and examples described herein are given by way of illustration only, and not by way of limitation. Various substitutions, modifications, additions, and rearrangements may be made without departing from the spirit of the present invention. Therefore, the description that follows is not to be taken in a limited sense, and the scope of the present invention is defined only by the appended claims.

The present disclosure provides for using auto calibration of a DTS system. In one respect, the DTS system may include a light source emitting a wavelength λ₁. Resulting spontaneous and stimulated Raman effect occurring in sensing fiber of the DTS system may be used to calibrate the system. The use of a single optical source may also be used to determine temperature measurement thus reducing the component count inside DTS system as well as lowers the cost and simplifies the manufacturing of the system and increase reliability.

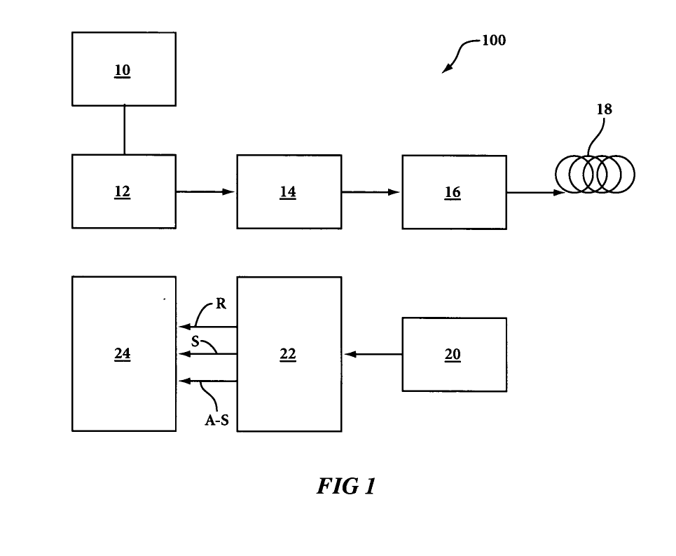

FIG. 1 illustrates a block diagram of a DTS system 100, in accordance with embodiments of the present disclosure. DTS system 100 may include a light source 12, a driver 10, a variable optical attenuator (VOA) 14, an optical coupler 16, sensing fiber 18, an optical filter 20, a photo detector 22, and a processor 24. Light source 12 may be any electromagnetic radiation source configured to transmit an optical signal (e.g., light) through VOA 14, optical coupler 16 to the sensing fiber 18.

In one embodiment, light source 12 may be a 1064-nanometer laser source or a 980-nanometer laser source. Other light sources operating at different wavelengths may be used. Light source 12 may generate a signal of constant energy, and the input energy level to sensing fiber 18 may be controlled by driver 10 or by variable optical attenuator (VOA) 14.

VOA (14) may be any commercially available or custom designed variable optical attenuation device based on electro-optical, electro-mechanical, and/or acousto-optical working principles. The VOA may be used to adjust the output power of optical source 12, which may be used to identify parameters (e.g., temperature parameters) as well as to automatically calibrate system 100.

Driver 10 may be any commercially available or custom designed variable current driver configured to adjust light source 12 such that different optical power signals may be transmitted to sensor fiber 18.

Optical coupler 16 may be used to transmit the output of light source 12 to sensing fiber 18. Optical coupler 16 may collect any backscatter from sensing fiber 18 and transmit it to optical filter 20, which filters the various backscatter components (e.g., the Raman components including the Rayleigh component, anti-Stokes component, Stokes component, etc.). Photo detector 22 which may include one or more single and/or multi-mode detectors may be used to detect the filtered backscattered components.

Processor 24 may be any system or apparatus configured to process the information from the backscatter components and determine various parameters, including for example, a temperature profile. For example, processor 24 may be any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, processor 24 may be any data acquisition hardware, personal computer, a network storage device, a controller, or any other suitable device and may vary in size, shape, performance, functionality, and price. Processor 24 may include random access memory (RAM), one or more processing resources such as a central processing unit (CPU) or hardware or software control logic, ROM, and/or other types of nonvolatile memory. Additional components of processor 24 may include one or more disk drives, one or more network ports for communicating with external devices as well as various input and output (I/O) devices, such as a keyboard, a mouse, and/or a video display. Processor 24 may also include one or more buses operable to transmit communications between the various hardware components.

The present disclosure describes light source 12 emitting a wavelength λ₁ at a first power level to generate a spontaneous Raman effect and at a second and higher power level to generate a stimulated Raman effect occurring in sensing fiber 18 to use elements of both effects to automatically calibrate system 100, using two regimes of Raman scattering, the spontaneous and stimulated Raman regimes.

The use of a single optical source, e.g., light source 12 may also determine temperature measurement thus reducing the component count inside DTS system 100 as well as lower the cost and simplify the manufacturing of the system and increase reliability.

In a lower power mode, system 100, operating in a spontaneous Raman regime, uses light source 12 to transmit an optical signal with a wavelength λ₁ through optical coupler 16 to sensing fiber 18 operating in a lower power linear transmission mode. During the transmission of optical signal to sensing fiber 18, a portion of the light may be scattered and may be filtered by optical filter 20 and detected by photo detector 22. The backscattered light may include light components such as Rayleigh (λ₁^{R}), Stokes (λ₁^{Stokes}), and anti-Stokes (λ₁^{anti-Stokes}). Processor 24 may collect the backscattered light.

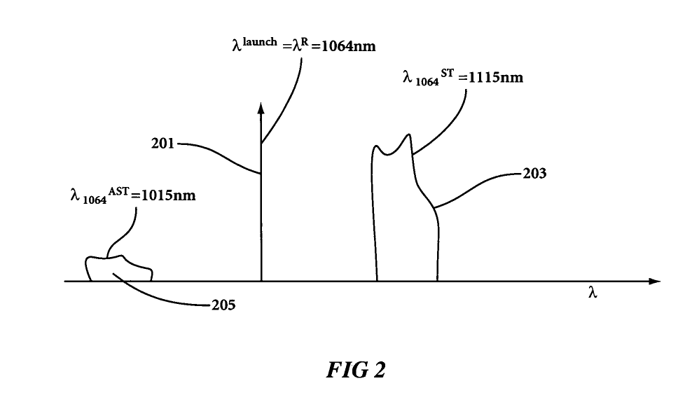

FIG. 2 illustrates an optical spectrum of backscattered light in the spontaneous Raman regime using as one example a light source with primary wavelength 1064 nm. Component 201 is a Raleigh component with about the same wavelength as transmitted optical signal from light source 12 (e.g., λ₁^{R}=λ₁). Component 203 and 205 are Stokes and anti-Stokes components respectively with wavelengths that differ from the optical signal from light source 12—in this particular example they have wavelengths of approximately 1015 nm (anti-Stokes) and 1115 nm (Stokes).

Additionally, in some embodiments, processor 24 may collect the power of the backscattered light as a function of time, which may be used to determine the temperature profile of system 100. If λ₁ is a low power pulse, the power of the Raman Component, P_{λ1}^{R}, may be greater than the power of the Stokes component, P_{λ1}^{ST}, which may be greater than the power of the anti-Stokes component, P_{λ1}^{AST}. Processor 24 may use the power obtained from the backscatter components to determine the temperature profile. During this phase processor 24 may also collect OTDR attenuation profiles of backscattered spontaneous Rayleigh and/or Raman Stokes signals.

In a next step driver 10 may increase the launch power of light source 12 (e.g., decrease the attenuation offered by VOA) to sensing fiber 18 which may drive system 100 into the stimulated Raman Scattering domain. In one embodiment, processor 24 may be coupled to driver 12 and may automatically trigger driver 12 to make the adjustments. In alternative embodiments, driver 12 may be manually changed or a controller (not shown) may be used to control driver 12.

Under the stimulated Raman regime, λ₁^{Stokes} increases significantly in optical power and becomes another light source, which then creates spontaneous Raman backscattering. For convenience, λ₁^{Stokes} in the stimulated Raman regime is denoted λ₂. The higher power Stokes signal λ₂ may generate its own backscatter as it travels down sensor fiber 18, namely Stokes (λ₂^{ST}) and anti-Stokes (λ₂^{AST}). The anti-Stokes signal centered around λ₂^{AST} is a wideband optical signal with typical bandwidth of around +/−15 nm. The temperature sensitive anti-Stokes signal centered around λ₂^{AST} may be close to the primary laser wavelength namely λ₁ and thus, may need to be notch filtered to remove λ₁ component.

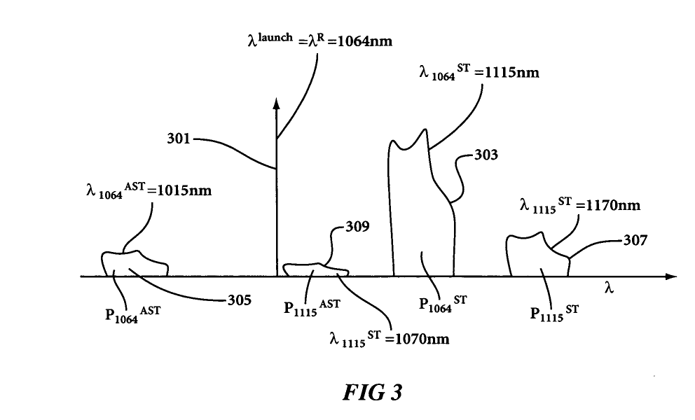

For example, referring to FIG. 3, light source 12 may be a 1064 nm light source outputting an optical signal to sensing fiber 18 (e.g., λ₁=1064 nm). The resulting backscatter from this transmission includes the Rayleigh component 301 which has a wavelength λ₁^{R} substantially similar to λ₁, a Stokes component 303 with a wavelength, λ₁^{Stokes}, of about 1115 nanometers, but with much higher power than the Stokes component 203 of FIG. 2, and an anti-Stokes component 305 with a wavelength, λ₁^{anti-Stokes}, of about 1015 nanometers. Thus the 1064 nm launch signal is stimulating a 1115 nm signal 303 which by itself becomes a light source of sufficient strength to give rise to its own spontaneous Raman back-scattered signals—namely a temperature sensitive anti-Stokes signal 309 and a temperature independent Stokes signal 307 as well as it's own Rayleigh signal 303.

Stokes component 307 in this example is approximately 1170 nm and the anti-Stokes component 309 is approximately 1070 nm. Processor 24 may also collect the power levels of Stoke component 307 (P₂^{ST}) and the power of the anti-Stokes component 309 (P₂^{AST}) to determine the temperature, T, as follows:

$$a . 1 / T ∝ \frac{{P}_{2}^{ST}}{{P}_{2}^{AST}} . \qquad Eq . 1$$

Or processor 24 may collect the power levels of Rayleigh component 303 (P₂^{R}) and the power of the anti-Stokes component 309 (P₂^{AST}) to determine the temperature T as follows:

$$1 / T ∝ \frac{{P}_{2}^{R}}{{P}_{2}^{AST}} \qquad Eq . 2$$

This disclosure anticipates that either mode can be implemented. For auto calibration purposes processor 24 may measure the OTDR attenuation profile of the spontaneous backscattered Rayleigh signal and the spontaneous backscattered Raman Stokes signal.

During the auto calibration mode, when we wish to collect temperature independent attenuation profile of sensor fiber at λ₂^{AST}, we may reduce the drive current of the primary laser source and collect the backscattered Rayleigh signal at λ₁ to represent the attention profile of λ₂^{AST}.

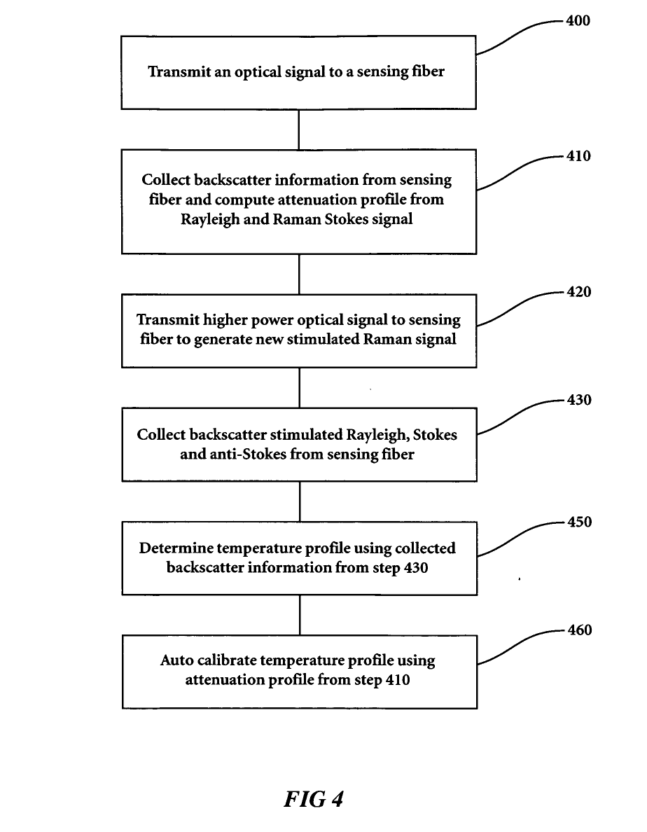

Turning now to FIG. 4, a flowchart of a method for auto calibrating a DTS system is shown, in accordance with embodiments of the present disclosure. At step 400, the system operating in a spontaneous Raman regime, may transmit an optical signal from light source 12 to sensing fiber 18. The transmission of the first optical signal may cause backscattering. At step 410, the backscatter may be filtered, detected, and collected using optical filter 20, detector 22, and processor 24 respectively. In one embodiment, the Rayleigh component λ₁^{R}, Stokes component λ₁^{Stokes}, and anti-Stokes component λ₁^{anti-Stokes} may be collected as well as the corresponding power levels. OTDR attenuation profiles may be collected for the spontaneous backscattered Rayleigh signal λ₁^{R} and the spontaneous backscattered Raman Stokes signal λ₁^{Stokes}.

At step 420, driver 10 transmits a higher power level to light source 12 or VOA 14 adjusts light source 12 strength. The increase in the optical signal may result in an increase in the power level of the Stokes component collected at step 410. Using this Stokes component as a second light source operating at λ₂, at step 430, the corresponding backscatter from the collected Stokes component λ₂^{Stokes} is obtained. In one embodiment, the Rayleigh component λ₂^{R} the Stokes component λ₂^{Stokes} an the anti-Stokes component λ₂^{AST} may be collected at step 430. Additionally, the power levels of the backscattered components collected at step 430 may be obtained as well.

At step 450, using the backscatter information collected at step 410 and step 430, a temperature profile may be determined. Backscatter components collected at step 430 (e.g., the power level P₂^{R} of the Raleigh component or the power level P₂^{ST} of the stimulated Raman Stokes component along with the power level P₂^{AST} of the stimulated Raman anti-Stokes component) may be used to determine the temperature profile. Either P₂^{R} or P₂^{ST} may be used for this computation and this disclosure anticipates either.

At step 460 the auto-calibration is performed on the temperature profile(s) obtained in step 450, made possible by the step 410 collections of temperature insensitive OTDR attenuation profiles from the spontaneous backscattered Rayleigh signal λ₁^{R} and the spontaneous backscattered Raman Stokes signal λ₁^{Stokes}. It is the collection of temperature insensitive Raleigh backscatter signal at λ₁ that is co-located with temperature sensitive anti-Stokes signal λ₂^{AST} that enables us to get an equivalent attenuation or loss profile of the sensor fiber.

Some or all of the steps of the flowchart of FIG. 4 may be implemented using system 100 of FIG. 1 or any other system operable to implement the method. In certain embodiments, the method illustrated in FIG. 4 may be implemented partially or fully in software embodied in tangible computer readable media. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or a physical or virtual storage resource.

Although certain embodiments of the present invention and their advantages have been described herein in detail, it should be understood that various changes, substitutions and alterations can be made without departing from the spirit and scope of the invention as defined by the appended claims. Moreover, the scope of the present invention is not intended to be limited to the particular embodiments of the processes, machines, manufactures, means, methods, and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods, or steps.

We claim:

1. A method for auto correcting temperature measurement in a system using a fiber optic distributed sensor and a single light source comprising the steps of:
a. transmitting a first optical signal from said single light source at a first power level, said first optical signal generating a first set of backscattered spontaneous Rayleigh, Raman Stokes, and Raman anti-Stokes signals;
b. collecting, filtering, and measuring said first set of backscattered signals from said first optical signal and calculating an OTDR attenuation profile of said spontaneous backscattered Rayleigh signal and said spontaneous backscattered Raman Stokes signal;
c. transmitting a second optical signal from said single light source at a second and higher power level; said second power level sufficient to generate a new stimulated Raman Stokes signal of higher power than said first spontaneous Raman Stokes signal;
d. collecting, filtering, and measuring a second set of backscattered stimulated Rayleigh, Raman Stokes, and Raman anti-Stokes signals from said new stimulated Raman Stokes signal;
e. calculating a temperature profile based on said second set of backscattered stimulated Rayleigh, Raman Stokes, and Raman anti-Stokes signals from said new stimulated Raman Stokes signal; and
f. auto calibrating said temperature profile using the OTDR attenuation profile of the backscattered spontaneous Rayleigh, backscattered spontaneous Raman Stokes, and/or backscattered stimulated Raman Stokes signals.
